(19) United States
(12) Patent Application Publication
(10) Pub. No.: US 2026/0350031 A1
(43) Pub. Date: Nov. 5, 2026

(54) DATA SEGMENTATION REVIEW SYSTEM

(71) Applicant: Wells Fargo Bank, N.A., San Francisco, CA (US)

(72) Inventors: Juan Pablo Gutierrez, JR., Whittier, CA (US); Winthrop Treynor Smith, Littleton, CO (US)

(21) Appl. No.: 19/199,003

(22) Filed: May 5, 2025

(51) Int. Cl. G06F 16/25

(52) U.S. Cl. CPC G06F 16/25

(57) ABSTRACT

This disclosure describes techniques for segmenting the contents of files into chunks based on user input. In one example, this disclosure describes a system configured to generate data representative of a user interface that includes one or more user interface elements, wherein each of the one or more user interface elements corresponds to a portion of a normalized organizational format. The system is further configured to, based on receiving user input segmenting contents of a file via the user interface elements, generate one or more chunks, wherein each chunk of the one or more chunks is a subset of the contents of the file that includes one or more tokens and satisfies a token size limit. The system then outputs the one or more chunks for consumption by another computing system.

### TECHNICAL FIELD

This disclosure relates to artificial intelligence (AI) frameworks, and more specifically, to segmentation of data for use by AI frameworks.

### BACKGROUND

Artificial intelligence (AI) models and, more specifically, machine learning (ML) models, such as large language models and natural language processing models, may rely upon datasets that include large numbers of documents for a variety of functions. For instance, a chatbot may be trained on a corpus that includes millions of documents to provide answers to user queries. Due to token size limitations of the ML models, an entity may segment the corpus into comparatively smaller subsets to enable use by the ML models. Segmenting the corpus into smaller subsets ensures compatibility with the models while facilitating efficient processing and improved performance by helping the model focus on relevant data, reducing noise, and enhancing the quality of training or inference.

### SUMMARY

This disclosure describes techniques for segmenting the contents of files into subsets known as chunks based on user input. An organization may process files, such as documents, presentations, etc., into chunks for use by various systems (e.g., a chatbot that uses chunked data to answer questions) where the chunks are a subset of the contents of the files (e.g., a paragraph, sentences, etc.) that include one or more tokens. Traditional techniques for generating chunks (alternatively referred to as “chunking”) using purely automated systems may result in the creation of chunks that fail to retain the context of an associated portion of the contents of a file (e.g., break up sentences, improperly combine portions of paragraphs, etc.). Models and/or systems that rely on these chunks may experience hallucinations and other issues that reduce the accuracy of output of the models. For instance, a chatbot may hallucinate an incorrect answer to a question due to an improperly chunked portion of a document used to determine the answer.

According to the techniques of this disclosure, a computing system may generate chunks of contents of a file based on user input received via a user interface. The computing system generates data representative of the user interface including fields populated with sections of the file (e.g., title, chapter, subject, subject content, and the like) that are based on a normalized organizational format for a document. The user interface receives user input from a user to create or modify the segmentation of the contents of the file, particularly the subject content. For example, the computing system may determine when the subject content in a user-created segment is too long, e.g., exceeds a token size limit, and prompt the user to identify a chunk boundary within the subject content that retains the meaning or context of the subject content while satisfying the token size limit of models and/or systems that may use the chunks to generate output. Based on the user input, the computing system generates chunks that are subsets of the contents of the file and outputs the chunks for consumption.

The techniques of this disclosure may provide one or more technical improvements that provide practical advantages. For example, the generation of chunks based on user input may enable a system to more accurately chunk files than by an automated system alone. In yet another example, the receipt of user feedback on chunks generated by an automated chunking process may enable the system to improve the automated chunking process. Furthermore, the use of normalized organizational formats for the contents of files may enable the system to generate chunks that adhere to a standardized format for chunks and contents of the files, thereby enabling other systems to consume the chunks.

In an example, this disclosure describes a method that includes generating, by the computing system, data representative of a user interface that includes one or more user interface elements, wherein each of the one or more user interface elements corresponds to a portion of a normalized organizational format; based on receiving user input segmenting contents of a file via the user interface elements, generating, by the computing system, one or more chunks, wherein each chunk of the one or more chunks is a subset of the contents of the file that includes one or more tokens and satisfies a token size limit; and outputting, by the computing system, the one or more chunks for consumption by another computing system.

In another example, this disclosure describes a computing system that includes memory; and processing circuitry in communication with the memory and configured to: generate data representative of a user interface that includes one or more user interface elements, wherein each of the one or more user interface elements corresponds to a portion of a normalized organizational format; based on receiving user input segmenting contents of a file via the user interface elements, generate one or more chunks, wherein each chunk of the one or more chunks is a subset of the contents of the file that includes one or more tokens and satisfies a token size limit; and output the one or more chunks for consumption by another computing system.

In yet another example, this disclosure describes non-transitory computer-readable media, that includes instructions that, when executed, cause processing circuitry to generate data representative of a user interface that includes one or more user interface elements, wherein each of the one or more user interface elements corresponds to a portion of a normalized organizational format; based on receiving user input segmenting contents of a file via the user interface elements, generate one or more chunks, wherein each chunk of the one or more chunks is a subset of the contents of the file that includes one or more tokens and satisfies a token size limit; and output the one or more chunks for consumption by another computing system.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a conceptual diagram illustrating an example system for generating chunks of a file, in accordance with one or more aspects of the present disclosure.

FIG. 2 is a block diagram illustrating an example chunk system that manages segmentation of files into chunks, in accordance with one or more aspects of the present disclosure.

FIG. 3 is a conceptual diagram illustrating an example configuration of a chunk system, in accordance with one or more aspects of the present disclosure.

FIGS. 4A-4C are example user interfaces for segmenting the contents of files into chunks, in accordance with one or more aspects of this disclosure.

FIG. 5 is a flow diagram illustrating an example process of chunk verification, in accordance with one or more aspects of the present disclosure.

FIG. 6 is a flow diagram illustrating an example process of generating chunks as a user enters data, in accordance with one or more aspects of the present disclosure.

FIG. 7 is a flow diagram illustrating operations performed by an example chunking system, in accordance with one or more aspects of the present disclosure.

### DETAILED DESCRIPTION

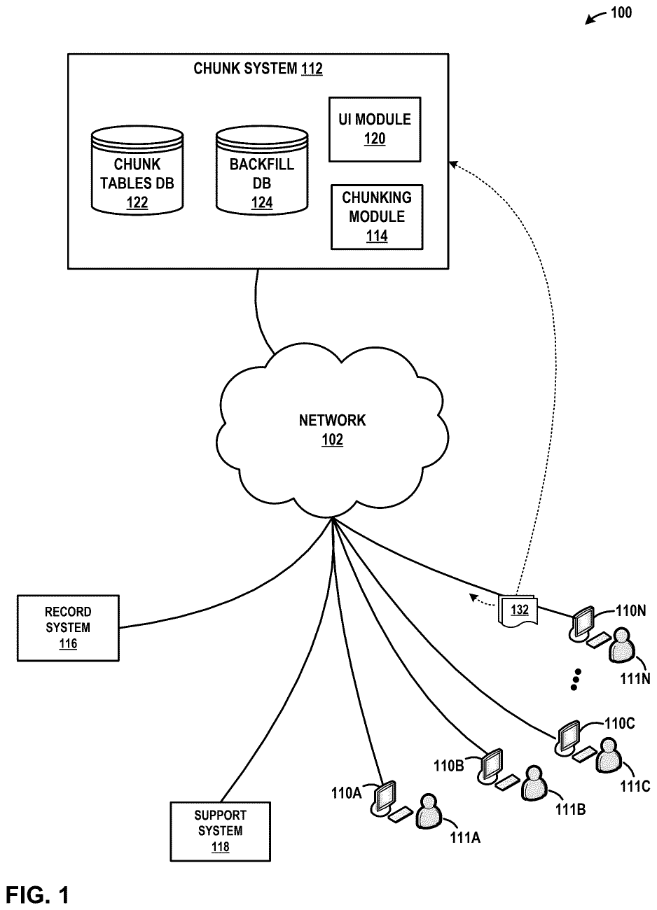

FIG. 1 is a conceptual diagram illustrating an example system 100 for generating chunks of a file, in accordance with one or more aspects of the present disclosure. In the example of FIG. 1, system 100 includes network 102, user devices 110A-N (hereinafter “user devices 110”), chunk system 112, record system 116, and support system 118. System 100 may be managed by one or more types of institutions, such as a financial institution.

Network 102 may include one or more networks, such as cloud networks (e.g., public cloud, private cloud), distributed networks, remote networks, on-premises networks, and/or other types of networks. Network 102 may be a network that logically connects one or more services together within a network or collection of networks. Network 102 may facilitate connections between various computing systems and device. For instance, network 102 may enable user devices 110 to communicate with other computing systems of an institution.

User devices 110 may implemented as any appropriate computing device, which may include devices such as laptops, desktops, smartphones, tablet computers, augmented reality (AR) glasses/goggles, or virtual reality (VR) glasses/goggles. Any of user devices 110 may, in some cases, correspond to other types of computing devices (e.g., servers, mainframes, virtual machines (VMs)). In many cases, user devices 110 are collectively implemented through a geographically distributed set of diverse computing devices across multiple physical offices of an organization. Each of user devices 110 may associated with a corresponding user of users 111A-111N (hereinafter “users 111”; e.g., user 111A is associated with user device 110A, user 111C is associated with user device 110C, and so forth). Users 111 may use user devices 110 to interact and communicate with other systems and devices of system 100. In an example, user 111A uses user device 110A to access information maintained by record system 116.

Record system 116 may be a computing system configured to maintain records and other information for the institution of system 100. Record system 116 may maintain various types of records, such as policy documents, user information, web pages, presentations, and/or other information. For example, record system 116 may maintain a central repository of policy documents for the institution.

Support system 118 may be a computing system of example system 100 configured to support users 111. Support system 118 may enable users 111 to search for files, request information, and perform other tasks. For instance, support system 118 may enable users 111 to search for policy documents relevant to job responsibilities. As part of supporting users 111, support system 118 may provide one or more types of machine learning (ML) models that include large language models (LLMs), natural language processing (NLP) models, and/or other types of models. In an example, support system 118 receives a request from user device 110A for information regarding a particular policy of the institution and uses a language model to process the request. Based on the request, an LLM causes support system 118 to retrieve the contents of a relevant file from record system 116 and provides a response to the request based on the contents of the file to user device 110A.

Support system 118 may use files (e.g., documents, presentations, web pages, etc.) that have been segmented. The models and other systems provided by support system 118 may process tokens up to a predetermined token size limit, where the token size limit corresponds to the maximum number of tokens that a model is configured to process within a single chunk. Support system 118 may utilize a token size limit to avoid providing an input (e.g., a prompt) to a model that exceeds the maximum size of an input that the model is configured to process. Support system 118 may configure one or more sources of data for the models to conform with token size limits or chunk reassembly of each model provided by support system 118. At least one of the sources of data for the models may comprise a retrieval augmented generation (RAG) system. As an example, support system 118 may be configured to support an LLM, which has a predetermined token size limit. Support system 118 may configure a RAG to provide chunks up to the token size limit associated with the LLM when generating prompts for the LLM. For example, support system 114 may configure the RAG to provide chunks when “prompt stuffing” prompts to the models with contextual information to constrain the output of the LLM and/or chunk reassembly to improve the accuracy of the LLM's output.

Chunk system 112 may be a computing system configured to process files maintained by record system 116 into segments (alternatively referred to as “chunks”). Chunk system 112 may generate chunks of files to enable consumption of the files by support system 118. For example, chunk system 112 may break up files into chunks small enough such models executed by support system 118 may consume the resulting vectors. Chunk system 112 may generate chunks based on the maximum number of tokens that a model may consume and from which the vector is generated. In an example, chunk system 112 obtains a policy document from record system 116. Chunk system 112 processes the policy document to generate chunks based on a predetermined token size limit and provides the chunks to support system 118. In some examples, chunk system 112 may provide a chunked version of a file to record system 116.

Traditional techniques for segmenting or “chunking” files may result in chunks that fail to retain the context of an associated portion of a file. For example, an automated process for chunking may generate chunks that break up paragraphs, sentences, and/or words in undesirable or incorrect ways. The use of incorrectly chunked files may cause models to hallucinate or otherwise generate undesirable outputs (e.g., outputting incorrect or hallucinated information). For instance, a system configured to provide policy information to users may provide incorrect answers due to improper chunking of policy documents. Furthermore, existing chunking strategies applied after the creation of files may vary in application and cause inconsistencies between development teams and data points. For example, chunking a file after creation may introduce inaccuracies into the chunking, such as inaccuracies arising from development teams assigned to handle different sets of files chunking the different sets of files in different ways, development teams misunderstanding the contents of the files that are being chunked, etc. Furthermore, existing chunking systems may not consult subject matter experts to confirm or verify that generated chunks retain context accurately. Existing chunking strategies may not be able to ensure the chunks do not cut off content mid-paragraph or, conversely, reassemble or combine content from different paragraphs or sections into a single chunk. This mishmash by existing chunking systems may introduce context-less or context-conflicting information, causing AI models to generate “hallucinations” or fabricate details that are not present in the original text. These inaccuracies may undermine reliability of LLMs and associated RAG systems and erode user trust.

In accordance with the techniques of this disclosure, chunk system 112 generates chunks of the contents of a file based on user input. Chunk system 112 generates data representative of a user interface (UI) that includes UI elements that each correspond to a portion of a normalized organizational format and obtain user input segmenting contents of the file via the UI. Based on the user input, chunk system 112 generates one or more chunks and outputs the chunks.

Chunk system 112 may obtain a file from one or more sources, such as record system 116, for user review via the UI. Chunk system 112 may obtain one or more types of files, such as documents, presentations, web pages, and/or other types of files, based on user selection of a file, automated selection of file, and/or other factors. In an example, chunk system 112 receives user input selecting a policy document maintained by record system 116. Chunk system 112 obtains the policy document from record system 116 based on the user input.

In some examples, chunk system 112 may select a previously chunked file for user review as part of obtaining a file. Chunk system 112 may analyze previously chunked files and determine whether a file was incorrectly chunked. Based on determining that a file was incorrectly chunked, chunk system 112 may present the file for user review of the chunking. In an example, chunk system 112 obtains a previously chunked file from record system 116. Chunk system 112 processes the file and determines that the file was incorrectly chunked. Chunk system 112 presents the file for user review via the UI.

In some examples, chunk system 112 may receive user input composing the contents of a file as part of obtaining a file. Rather than obtaining a previously created file, chunk system 112 may provide the user interface to a user device of user devices 110 for a user of users 111 to draft or compose the contents of a file for processing by chunk system 112. In an example chunk system 112 generates a user interface as including fields for a user to enter text and provides data representative of the user interface to user device 110A for user device 110A to display the user interface. User device 110A receives user input from user 111A entering text into the fields and provides data representative of the user input to chunk system 112.

Chunk system 112 may use one or more components, such as UI module 120, to generate a user interface for display. UI module 120 may be a software component of chunk system 112 configured to generate UIs to enable a user to segment a file using UI elements. UI module 120 may generate the UI such that each UI element corresponds to a section of the file or a document tree, such a document title user interface element, a user information element, a document summary element, a document keyword user interface element, a chapter title user interface element, a chapter keyword user interface element, a chapter subject title element, a chapter subject content chunk user interface element, etc. In an example, UI module 120 generates a UI that includes UI elements that each correspond to a portion of a document tree. UI module 120 may output a UI for display via output components of chunk system 112 or provide the UI to one or more of user devices 110 for display.

In some examples, UI module 120 generates the UI based on a normalized organizational format that specifies formatting of the contents of a file. Chunk system 112 may maintain templates for one or more types of files (e.g., documents, presentations, web pages, etc.) that specify formatting of the corresponding type of file. For example, chunk system 112 may maintain a normalized document template that specifies organization of the document, typeface, and/or other information. Chunk system 112 may use the templates to ensure that documents generated and processed by chunk system 112 adhere to normalized file formats used by other systems of system 100, such as support system 118. For instance, support system 118 may require that files used by support system 118 be in normalized formats to ensure that one or more components or functions are configured to utilize the files (e.g., models, search functions, etc.). UI module 120 may select a template based on the type of file (e.g., document vs presentation) and generate the UI based on the template. In an example, chunk system 112 obtains a presentation file for review by user 111A. UI module 120 selects a presentation template based on the type of the file and generates a UI based on the presentation template. UI module 120 provides data representative of the UI to user device 110A.

UI module 120 may receive user input, such as user input 132, segmenting a file via the UI. UI module 120 may receive user input 132 as including one or more types of input, such as entering of text into UI elements, selecting boundaries of portions of the contents of a file, and/or other types of user input. In some examples, UI model 120 may enable users 111 to create a file by entering data (e.g., text, images, etc.) into the UI elements or by modifying a preexisting file for which content is prepopulated into the UI elements. For example, UI module 120 may generate the UI with one or more fields (e.g., fields corresponding to various sections of a normalized organizational format) prepopulated with corresponding portions of contents of a preexisting file for the user to modify the contents of the file.

In some examples, UI module 120 generates a published representation of a file and displays the published representation. UI module 120 may generate a published representation of a file as representative of the appearance of the contents of a file when the file is published. UI module 120 may generate the published representation in real-time as a user is interacting with a UI to enable a user to visualize the appearance of the contents of a file when published. In an example, chunk system 112 receives user input 132 from user device 110A as entering text into fields of the UI to create a document. UI module 120 updates the UI as the user is interacting with the UI to include a published representation of the document as the text is entered.

Chunk system 112 may use one or more components, such as chunking module 114, to generate chunks based on received user input. Chunking module 114 may be a software component of chunk system 112 configured to generate chunks of a file. Chunking module 114 may generate chunks in response to user input and/or automatically as part of an automated chunking process. Chunking module 114 may generate the chunks in one or more ways that include generating indications of the boundaries of each chunk within a file (e.g., start and stop points within the file), extracting the contents of a file included in a chunk from the file, and/or other ways. For example, chunking module 114 may generate chunks by updating a table to include indications of boundaries associated with each chunk of a file. In some examples, chunking module 114 may generate chunks in real-time or near real-time.

Chunking module 114 may perform automated chunking of files, such as those maintained in backfill database 124. Backfill database 124 may include one or more types of databases and/or file repositories in which chunk system 112 stores files for chunking (e.g., files obtained from record system 116) that have not yet been chunked and/or that require review of chunking. Chunk system 112 may use chunking module 114 to performed automated chunking of files to reduce the number of files needed to be processed by users 111. For instance, chunk system 112 may automatically chunk a portion of files in backfill database 124 and request that a user determine the chunking of other files in backfill database 124.

Chunk system 112 may determine whether a previously chunked file was incorrectly chunked. Chunk system 112 may obtain information regarding the chunking of the file (e.g., information regarding the contents of the chunks) from chunk tables database 122 for use in determining whether a file was incorrectly chunked. Chunk system 112 may determine whether a given file was incorrectly chunked in one or more ways, such as by applying a model trained to identify incorrect chunking, applying one or more rules (e.g., determining that a sentence has been separated into different chunks, determining that a word has been broken into different chunks, etc.), applying heuristics, and/or other ways of determining whether a file was incorrectly chunked. In an example, chunk system 112 obtains information regarding the chunking of a document from chunk tables database 122. Chunk system 112 analyzes the chunking of the document and determines that multiple sentences within the document were each segmented into different chunks. Chunk system 112 determines that the document was incorrectly chunked and outputs an indication of the incorrect chunking.

Chunk system 112 may request that a user review or verify the chunking of files, such as files that chunk system 112 determined were incorrectly chunked. Chunk system 112 may generate a request for user review and provide the request to one or more user devices 110. For example, UI module 120 may generate a visual indication within a UI provided to one of user devices 110 to alert a user to the incorrect chunking of a document. Chunk system 112 may receive user input 132 including whether corrections are required. For example, chunk system 112 may receive user input 132 as including user feedback via a user interface that includes indications of changes or modifications to the chunk boundaries.

Chunk system 112 may revise or modify the automated chunking process based on user input 132. Chunk system 112 may modify the automated chunking process in one or more ways, such as by retraining models, modifying rules, and/or by performing other actions. Chunk system 112 may modify the automated chunking process as part of a feedback loop that includes automated chunking, user feedback on the automated chunking, and updates to the automated chunking. Chunk system 112 may use the feedback loop to iteratively improve the accuracy of the automated chunking process and reduce the need for human intervention/interaction.

In some examples, chunk system 112 may obtain user input 132 as including user verification that a file has been correctly chunked. Chunk system 112 may obtain user verification as a user may be capable of understanding the context of the content of the file and determining whether the file was correctly or incorrectly chunked to retain the context. For instance, chunk system 112 may obtain user verification to override a determination that a file was incorrectly chunked to leverage the user's subject matter expertise. In addition to requesting verification from a first user, chunk system 112 may request verification from one or more additional users. Chunk system 112 may request verification from additional users as a matter of course (e.g., regularly requiring multiple sources of verification), based on determining that a user has incorrectly verified the chunking of a file, based on determining that a user is perfunctorily or not consistently verifying the chunking, and/or based on other factors.

Chunk system 112 may store the chunks in chunk tables database 122, which may be a data structure configured to maintain chunk data. Chunk system 112 may store chunked versions of files in tables of chunk tables database 122, where the tables are organized in one or more ways, such as start and end point of each chunk within a file, each chunk as a separate entry associated with a file, and/or in other ways. In an example, chunk system 112 generates chunks of a file. Chunk system 112 stores each chunk within a table maintained in chunk tables database 122 and associated with the file. In some examples, chunk system 112 outputs chunks to one or more recipients, such as record system 116 and/or support system 118.

Chunk system 112 may generate vectors based on the chunks. Chunk system 112 may vectorize the tokens within a given chunk for use by other systems, such as record system 116 and/or support system 118. In an example, chunk system 112 generates a chunk of a file based on user input. Chunk system 112 generates a vector of the chunk based on tokens included in the chunk and provides the vector to record system 116 for record system 116 to maintain. Chunk system 112 may generate vectors based on the chunks for feeding to models to generate fact-based, coherent responses.

Support system 118 may use vectors maintained by record 116 as part of supporting users 111. One or more models or other systems provided by support system 118 may retrieve the embeddings to support users 111 in one or more ways, such as answering questions. Support system 118 may use a RAG system when supporting users 111, such as by retrieving chunked information from record system 116 for consumption by models provided by support system 1118. Support system 118 may rely on the accuracy of the chunking of the information retrieved from record system 116, making proper chunking of the information critical for providing accurate information to users 111. In an example, support system 118 receives an inquiry from user device 110A regarding a policy of the institution. A language model of support system 118 causes support system 118 to retrieve a vector associated with a relevant policy document and process the vector. The language model generates an output that includes an answer to the inquiry and causes support system 118 to provide the answer to user device 110A. In another example, support system 118 retrieves a chunk of information from record system 116 via a RAG system, where the chunk has been verified by chunk system 112. Support system 118 provides information to users 111 based on the verified chunk to enable the users to receive accurate information.

The techniques of this disclosure may provide one or more technical improvements that provide practical advantages. For example, the generation of chunks based on user input may enable a system to more accurately chunk files. In another example, the receipt of user feedback on chunks generated by an automated chunking process may enable the system to improve the automated chunking process. Furthermore, the use of normalized formats for the contents of files may enable the system to generate chunks that adhere to a standardized format for the chunks and the contents of the files, thereby enabling other systems to consume the chunks. In yet another example, the generation and/or verification of chunking may enable a support system to rely upon a RAG system that uses the chunk to constrain the output of a language model.

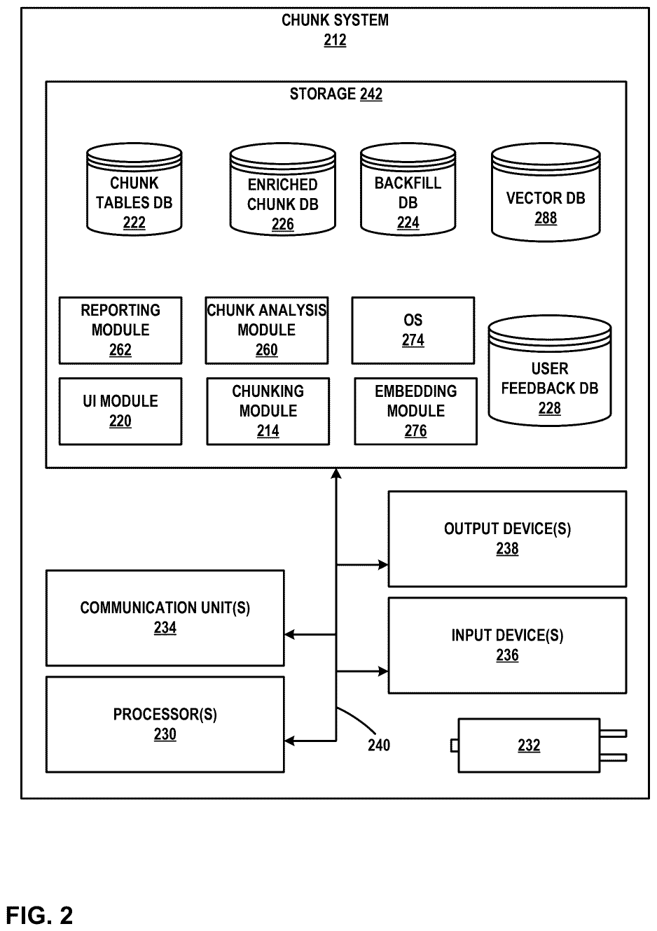

FIG. 2 is a block diagram illustrating an example chunk system 212 that manages segmentation of files into chunks, in accordance with one or more aspects of the present disclosure. Chunk system 112 may be an instance of chunk system 112 as illustrated in FIG. 1.

In FIG. 2, chunk system 212 comprises a computing system that includes one or more processors 230, which may include mobile processors, desktop processors, server processors, compute nodes, virtualized processors, processing circuitry, and/or other types of processors. Processors 230 may execute the instructions of one or more processes of chunk system 212 and implement functionality of the one or more processes.

Chunk system 212 includes one or more of communication units 234, which may include one or more components such as network interface cards (NICs), wireless radios such as cellular modems and WIFI radios, transceivers, and other components. Communication units 234 may enable chunk system 212 to communicate with other computing devices and systems using any appropriate communication protocol (e.g., TCP/IP). Communication units 234 may enable chunk system 212 to communicate with any other device illustrated in FIG. 1, such as record system 116, support system 118, and user devices 110.

Chunk system 212 includes power source 232, which may include one or more sources of power such a connection to an electrical grid, a connection to local power sources (e.g., solar, battery, power generation system, or various backup systems), and/or other sources of power. Power source 232 may provide the power that enables chunk system 212 to operate.

Chunk system 212 includes input devices 236 and output devices 238. Input devices 236 may include one or more devices capable of providing input to chunk system 112 such as keyboards, mice, touchscreens, touchpads, microphones, video cameras, and other types of input devices. Output devices 238 may include one or more devices capable of generating output such as displays, speakers, haptic engines, light indicators, and other devices capable of generating output.

Chunk system 212 includes communication channels 240, which may include one or more components such as hardware connections, software connections, hardware interconnects, and other components. Communication channels 240 may interconnect one or more components of chunk system 212 and enable communication between the components of chunk system 212. For example, communication channels 240 may interconnect processors 230 and storage 242.

Chunk system 212 includes storage 242, which may include one or more storage components such as hard disk drives, solid state drives, magnetic tape drives, disk drives, virtualized storage, cloud storage, and other components. Storage 242 may store instructions and data for one or more software components of chunk system 212. For example, storage 242 may store instructions of an operating system (OS) for execution by processors 230. While illustrated as separate components, one or more of the software components of chunk system 212 included in storage 242 may operate as a plugin or other type of module for a software component of a user device (e.g., as a plugin for a word processing application).

Storage 242 includes operating system 274 (illustrated as “OS 274”, hereinafter referred to as the same), which may provide a software platform on which various processes executing on chunk system 212 may operate. In general, OS 274 may provide an execution environment for one or more software components of chunk system 212, such as chunking module 214.

Storage 242 includes chunking module 214, which may be a software component of chunk system 212 configured to generate chunks of data files according to a token size limit. Chunking module 214 may be an instance of chunking module 114 as illustrated in FIG. 1 and provide similar functionality. For example, chunking module 214 may generate chunks based on user input received via a UI. In some examples, chunking module 214 may orchestrate the functionality of other software components of chunk system 212.

Storage 242 includes UI module 220, which may be a software component of chunk system 212 configured to generate data representative of UIs. UI module 220 may be an instance of UI module 120 as illustrated in FIG. 1 and provide similar functionality. For instance, UI module 220 may generate data representative of a UI including visual elements corresponding to a normalized organizational format for a document. In some examples, UI module 220 may generate data representative of a UI with visual elements prepopulated with contents of a file for a user to review chunking of the file. For example, chunk system 212 may cause UI module 220 to data representative of a UI for a user to review chunking of files.

Storage 242 includes chunk analysis module 260, which may be a software component of chunk system 212 configured to analyze and review chunks of data files. Chunk analysis module 260 may analyze chunks generated as part of an automated chunking process and/or review user-generated chunks. Chunk analysis module 260 may periodically analyze chunks (e.g., as part of an automated review process) and/or in response to user requests for review. Chunk analysis module 260 may analyze the chunks in one or more ways, such as by applying ML models, analyzing grammar and language of chunks (e.g., using one or more grammar/language rules to identify incorrect chunking such as mid-sentence or mid-word breaks between chunks), applying user-created/defined rules, and/or in other ways. In an example, chunk analysis module 260 obtains a set of chunks for a data file from chunk tables database 222, where the chunks are portions or partitions of a single file. Chunk analysis module 260 analyzes the set of chunks by analyzing the file using a language model. Chunk analysis module 260 then causes UI module 220 to generate data representative of a UI that includes a visual representation of the analysis of the set of chunks.

In some examples, chunk analysis module 260 may analyze files stored in a file store to determine whether the files are incorrectly chunked. Chunk analysis module 260 may analyze files stored in a file store that maintains a plurality of files (e.g., backfill database 224, record system 116 as illustrated in FIG. 1, etc.) using one or more techniques, such as applying a language model. Based on determining that a given file has been incorrectly chunked, chunk analysis module 260 may cause chunk system 212 to retrieve the file from the file store.

Chunk analysis module 260 may request user verification of the chunks. Chunk analysis module 260 may cause UI module 220 to generate data representative of a UI that includes a visual representation of chunks of a file to obtain verification from a user that a file has been correctly chunked. For instance, chunk analysis module 260 may obtain user verification of correct chunking to confirm the correctness of chunking performed by chunking module 214.

In some examples, chunk analysis module 260 may obtain secondary verification of chunks from a second user. Chunk analysis module 260 may determine whether to request secondary verification in addition to verification of chunks by a first user based on one or more factors, such as prior improper verification from the first user, a type of the document whose chunks are being verified (e.g., an important policy document), and/or other factors. Chunk analysis module 260 may cause UI module 220 to generate data representative of a UI that includes visual representation of the chunks of a file and provide the UI to a second user different from the user who provided the first verification. Chunk analysis module 260 may cause chunk system 212 to output chunks of the file based on the verification from the first user and the secondary verification from the second user.

Storage 242 includes chunk tables database 222 (illustrated as “CHUNK TABLES DB 222” as illustrated in FIG. 2), which may be a software component of chunk system 212 configured to store and/or maintain chunk data. Chunk tables 222 may be an instance of chunk tables database 122 as illustrated in FIG. 1 and provide similar functionality. For example, chunk tables database 222 may include one or more data structures that are configured to maintain chunk data. Chunk tables database 222 may maintain chunk data that includes chunked versions of files as tables, individual chunks of files, and/or other information. For example, chunk tables database 222 may store a table associated with given file, where the table includes indications of boundaries of each chunk within the contents of the file.

Chunk analysis module 260 may analyze the chunk data stored in chunk tables database 222. Chunk analysis module 260 may obtain chunks (e.g., information regarding the chunks from tables maintained by chunk tables database 222) from chunk tables database 222 as part of an automated chunk review process and/or in response to a user request to analyze chunks. As part of the automated chunk review process, chunk analysis module 260 may obtain chunks from chunk tables database 222 as the chunks are added to chunk tables database 222 (e.g., in response to the addition of chunks to chunk tables database 222), on a periodic basis, and/or based on other factors. For example, chunk system 212 may periodically obtain chunks from a record system (e.g., record system 116 as illustrated in FIG. 1) for analysis by chunk analysis module 260 and store the obtained chunks in chunk tables database 222. Chunk analysis module 260 may analyze the chunks in one or more ways (e.g., applying a language model) and provide an indication of the results of the analysis (e.g., whether a file was correctly chunked) to one or more recipients, such as reporting module 262 and/or UI module 220. In an example, chunk analysis module 260 receives an indication that chunks of a file have been added to chunk tables database 222. Chunk analysis module 260 obtains the added chunks and analyzes the added chunks to determine whether the files associated with the added chunks were correctly chunked. In response to determining that at least one of the files associated with the added chunks was incorrectly chunked, chunk analysis module 260 provides an indication to UI module 220 to generate data representative of a UI that includes an indication of the incorrect chunking and for the user to remedy the incorrect chunking. In some examples, chunk analysis module 260 may provide an indication of incorrect chunking to chunking module 214 for chunking module 214 to generate new chunks (e.g., correct the incorrect chunking of a file).

In some examples, UI module 220 may generate data representative of a UI in response to an indication from chunk analysis module 260 of incorrect chunking (e.g., that a file was incorrectly chunked). UI module 220 may generate data representative of a UI that includes visual elements corresponding to the chunks of the file and visual elements indicated which of the chunks were determined as incorrectly chunked. For instance, UI module 220 may generate the data representative of the UI including visual indications of the boundaries of the incorrect chunks. UI module 220 may enable a user to modify the chunking of the file (e.g., by modifying the boundaries of each of the chunks) via the UI. Chunk system 212 may generate one or more chunks based on the user input modifying the boundaries of the incorrect chunks within the contents of the file. UI module 220 may provide information representative of the user modification of the chunks to one or more recipients, such as user feedback database 228.

In some examples, UI module 220 may generate a data representative of a UI that includes an indication that a user-created chunk exceeds a token size limit. Chunk analysis module 260 may analyze chunks of a file as the user composes the file and determine whether the chunks exceed one or more token size limits. Based on determining that a chunk composed by a user (e.g., a chunk with user-defined boundaries) exceeds a token size limit, chunk analysis module 260 may cause UI module 220 to generate an indication that the chunk exceeds the size limit. In some examples, chunk system 212 may cause one or more components to automatically generate sub-chunks to correct the user-defined chunk that exceeds the token size limit.

Storage 242 includes user feedback database 228 (illustrated as “USER FEEDBACK DB 228” in FIG. 2), which may be a software component of chunk system 212 configured to store feedback on chunking of files. User feedback data 228 may store information representative of user modification to chunks of a file (e.g., user correction of incorrect chunks) and/or user creation of chunks (e.g., initial chunking of a file by a user). Additionally, user feedback data 228 may include information indicating whether users have validated the usefulness of the content, such as through mechanisms similar to a thumbs-up or thumbs-down system Chunk system 212 may use the information stored in user feedback database 228 in one or more ways, such as modifying rules used by chunking module 214 in generating chunks, modifying one or more ways in which chunk analysis module 260 determines that a file has been incorrectly chunked, and/or for other purposes. For example, chunk system 212 may use information regarding user correction of previous chunking or user validation feedback to modify the chunking performed by chunking module 214.

Chunk system 212 may provide benefits to the institution that include:
Centralization of platforms by centralizing the processing and chunking of files within chunk system 212. For instance, chunk system 212 may split documents into smaller, retrievable chunks, whereas traditional chunking algorithms may not be able to accurately determine where one thought ends and another begins. Chunk system 212 may avoid this oversight by traditional chunking algorithms that may lead to arbitrary splits that do not align with a document's natural divisions.
Enhanced Contextual Understanding: Chunk system 212 may modify a RAG system and improve the contextual understanding of information stored by record system 116 for models that consume chunks via the RAG system.
Reduced Hallucinations: Chunk system 212 may modify the RAG system using chunks generated by chunking module 214 to improve the recalling of information by models and thereby reduce the occurrence of hallucinations by the models.
Improved Embedding Quality: Chunk system 212 may improve embeddings used by the models through improvement in chunking performed by chunking module 214.
Improved User Experience: Chunk system 212 may use UI module 220 to generate UIs that enable users to easily modify chunks and to compose files for chunking.

Chunk system 212 may provide functionality that is beneficial to engineering subsets of the institution. For instance, chunk system 212 may provide benefits that include:
Centralized and uniform data normalization: Chunk system 212 may enable the use of normalized organizational formats for the contents of files and thereby ensure that chunked files are normalized. Chunk system 112 may leverage the most effective and most recent data normalization techniques would be leveraged to ensure optimal consistency and compatibility across all file contents
Reduced duplication: Chunk system 212 may enable the reduction in duplicated files stored in record system 116 as part of verifying the chunking of files.
Improved internal code sharing: Chunk system 212 may provide a centralized platform and thereby enable comparatively simpler sharing of code with respect to distributed chunking systems.
Less platforms and storage to use and pay for: Chunk system 212 may reduce the volume of data required to be stored by record system 116 and/or other systems and, as such, reduce the costs associated with supporting systems to store the data. In addition, chunk system 212 may avoid the need for multiple data sources that require additional overhead with costly vendor and storage fees and the need for custom code to account for the multiple file formats and different approaches by various lines of business. The creation of custom code for the variety of file types and formats may be complex and time consuming, requiring many engineers and duplicated work.
Less complicated custom coding: Chunk system 212 may reduce the need for software development associated with chunking systems by providing a single, centralized chunking system and removing the need for chunking systems specific to subsets of the institution.
Improved accuracy: Chunk system 212 may enable iterative improvement in chunking accuracy through use of a feedback loop that incorporates user feedback into the chunking of files.
Improved Knowledge Sharing: Chunk system 212 may improve the sharing of information among members of the institution through enabling support system 118 to operate as a centralized source of information using files chunked by chunk system 212.

Chunk system 212 may provide functionality that is beneficial to lines of business subsets for the institution. For instance, chunk system 212 may provide benefits that include:
Easier to use documentation system: Chunk system 212 may use UI module 220 to generate UIs that enable users to easily compose the contents of files in accordance with normalized organizational formats and to modify the boundaries of chunks within the contents of the files.
Improved Search Engines and Chatbots: Chunk system 212 may improve the accuracy and functionality of model-based systems (e.g., AI chatbots) by improving the chunking of files consumed by the systems.
More well-informed members: Chunk system 212 may enable members of the institution (e.g., employees) to receive accurate information via consumption of chunked files by support system 118.
Save time by not having to search through multiple platforms for answers: Chunk system 212 may enable chunking of a variety of files types and enable consumption by support system 118 and thereby enable support system 118 to provide a centralized source for members of the institution.
Avoid duplicate entries and multiple versions of the same content: Chunk system 212 may enable record system to avoid storing multiple copies or versions of a file by identifying duplicate copies of files and/or performing other types of file management.

Storage 242 includes backfill database 224 (illustrated as “BACKFILL DB 224” in FIG. 2), which may be a software component of chunk system 212 configured to store files for chunking. Backfill database 224 may be an instance of backfill database 124 as illustrated in FIG. 1 and provide similar functionality. Chunk system 212 may store files that are to be chunked or that are to be chunked again (e.g., files identified as incorrectly chunked) in backfill database 224 for use by other components of chunk system 212. For example, chunk system 212 may store a file received from record system 116 in backfill database for chunk system 212 to chunk.

Storage 242 includes enriched chunk database 226 (illustrated as “ENRICHED CHUNK DB 226” in FIG. 2), which may be a software component of chunk system 212 configured to store chunked copies of files. Chunk system 212 may generate enriched chunk database 226 based on information included in chunk tables database 222 (e.g., the tables indicating chunk locations). For example, chunk system 212 may generate data for inclusion in enriched chunk database 226 by chunking the contents of a given file within backfill database 224 based on the boundaries of chunks included in chunk tables 222 and store the chunked contents as separate chunked sections within enriched chunk database 226. While illustrated as separate components, in some examples enriched chunk database 226 may be included in chunk tables database 222. In some examples, chunk system 212 may store chunks of files in enriched chunk database 226 that chunk system 212 has verified as correctly chunked. For example, chunk system 212 may unverified chunks in chunk tables database 222 and chunks of files verified as correctly chunked in enriched chunked database 226.

Storage 242 includes embedding module 276, which may be a software component of chunk system 212 configured to generate vectors. Embedding module 276 may generate vectors (e.g., embeddings) of chunks generated by chunking module 214. In an example, chunking module 214 generates chunks of a file and stores the chunking in enriched chunk database 226. Chunk system 212 provides the chunks to embedding module 276 for embedding module 276 to generate vectors. Embedding module 276 vectorizes each of the chunks provided by chunk system 212 and stores the vectors in vector database 288.

Storage 242 includes vector database 288 (illustrated as “VECTOR DB 288” in FIG. 2), which may be a software component of chunk system 212 configured to store vectors of chunks. Chunk system 212 may store vectors in vector database 288 in one or more ways, such as in tables, graph databases, and/or in other ways. Chunk system 212 may store the vectors in vector database 288 for use by other components of chunk system 212 and/or other computing devices. For example, chunk system 212 may modify vector database 288 to include a vector for each chunk generated by chunk system 212 and provide the vectors to record system 116.

Storage 242 includes reporting module 262, which may be a software component of chunk system 212 configured to provide reporting functionality. Reporting module 262 may generate reports regarding assigned data owners of files and as including indications of users allowed to view and modifying chunking of files. For instance, reporting module 262 may generate reports regarding the data ownership of a particular set of files and provide the reports to a management team for review. In addition, reporting module 262 may generate data dashboards including similar data to enable management and/or other entities of the institution to determine which individuals are responsible for/assigned to particular files and the management of chunking those files. For example, reporting module 262 may generate dashboards with drill down functionality to enable users to view chunking of individual files and associated/responsible users.

In some examples, reporting module 262 may automatically generate reports, such as emails and other notifications, indicative of incorrect chunking. Reporting module 262 may automatically generate the reports based on a remediation timeline associated with the file. For example, chunk analysis module 260 may determine that a file was incorrectly chunked and an associated remediation timeline for the file based on one or more factors (e.g., the type of file, an assigned criticality of the file, a determined severity of the incorrect chunking, etc.). Based on an associated remediation timeline, reporting module 262 may automatically generate the reports. In some examples, reporting module 262 may include a link to enable a user to access the incorrectly chunked file or to request that UI module 220 generate data representative of a UI to display the incorrectly chunked file.

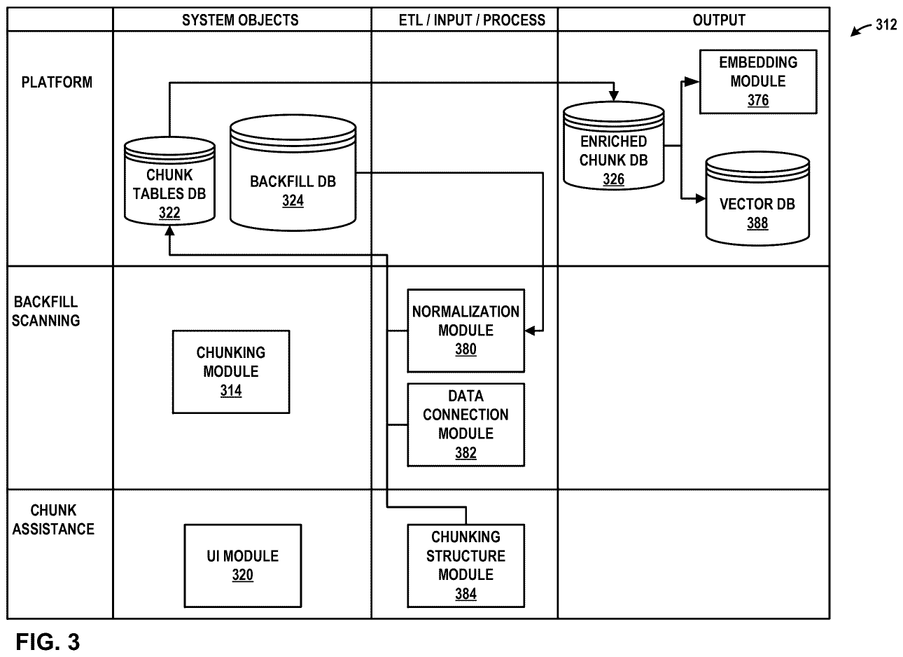

FIG. 3 is a conceptual diagram illustrating an example configuration of a chunk system 312, in accordance with one or more aspects of the present disclosure. Chunk system 312 may be an instance of chunk system 112 as illustrated in FIG. 1 and/or chunk system 212 as illustrated in FIG. 2. For example, UI module 320 may be an instance of UI module 120 and/or UI module 220. Other components of chunk system 312 may also be instances of components illustrated in FIG. 1 and/or FIG. 2. Chunk system 312 may be configured to enable a user to compose a file and segment the file into chunks that are portions or partitions of a file. Chunk system 3112 may include one or more stages and/or processes as illustrated in FIG. 3 (e.g., “SYSTEM OBJECTS”, “ETL/INPUT/PROCESS”, “OUTPUT”).

Chunk system 312 may provide user assistance to aid a user in segmenting files as part of “CHUNK ASSISTANCE”. Chunk system 312 may assist a user in one or more ways, such as causing UI module 320 to generate data representative of a UI to enable a user to compose the contents of a file and to segment the file. UI module 320 may generate a UI that includes visual elements corresponding to a portion of a normalized organizational format. For example, UI module 320 may use normalized organizational formats maintained by chunking structure module 384 when generating the UI.

Chunk system 312 may ensure accuracy by delivering an easy-to-use application that walks users through the creation of knowledge base content (e.g., via UI module 320). Chunk system 312 may use back-end components to ensure the content chunks are structured in a way that meets the AI token requirements while leveraging a human subject matter expert's content expertise to validate the chunking points. Chunk system 312 may ensure the meaning and overall message is preserved and that the content is chunked accurately at a granular level. Furthermore, chunk system 312 may enable users to create accurate chunking from creation, ensuring all AI knowledge base content is optimized moving forward. Users may leverage chunk system 312 to validate and edit content that has already been chunked or created and to provide feedback on the usefulness of the content, such as through mechanisms similar to a thumbs-up or thumbs-down system.

Chunk system 312 includes chunking structure module 384, which may be a software component of chunk system 312 configured to provide templates and assistance for chunking files. Chunking structure module 384 may maintain templates for one or more types of files and for subtypes of files such as templates for documents, presentations, and/or webpages. For example, chunking structure module 384 may maintain templates for one or more types of word documents, where the templates adhere to a normalized organizational format used by an organization to ensure standardization of the organization of files intended to be chunked and used by other systems (e.g., support system 118 as illustrated in FIG. 1) and to avoid the inherent complexity of storing and retrieving the contents of files with varying organizational formats when supporting users. Chunking structure module 384 may provide templates to UI module 320 for use in generating a UI based on the template. In an example, chunk system 312 receives user input consistent with requesting a UI for creation of a document and provides an indication to UI module 320. UI module 320 obtains a template from chunking structure module 384 and generates a UI based on the template. In some examples, chunking structure module 384 may be included in UI module 320.

In some examples, UI module 320 may generate a UI to enable a user to modify the chunking of a file. UI module 320 may obtain a template from chunking structure module 384 and prepopulate fields of the template with contents of the file. UI module 320 may prepopulate the fields of the template based on previous chunking of the file and/or based on an analysis of the file (e.g., determining which portions of the contents of the file should go into each field of the template). In an example, UI module 320 receives a previously chunked file selected for user review. UI module 320 obtains a template from chunking structure module 384 that includes fields for contents of the file. UI module 320 prepopulates fields of the template with contents of the file based on the chunks of the file for a user to review the chunks.

Chunk system 312 may use one or more components, such as chunking module 314, to perform chunking of files. Chunk system 312 may perform chunking of files as part of “BACKFILL SCANNING” to automatically chunk a backfill/backlog of files. For example, chunk system 312 may obtain files from a repository of files (e.g., from record system 116 as illustrated in FIG. 1) and store the files in backfill database 324 for chunking. Chunk system 312 may applying chunking module 314 to the files to automatically generate chunks of the files.

As part of automatically chunking files, chunking module 314 may use normalization module 380 to ensure that chunked versions of files adhere to a normalized organizational format. Normalization module 380 may be a software component of chunk system 312 configured to ensure that chunking of files adheres to the normalized organizational format and may be included in chunking module 314 in some examples. For example, normalization module 380 may analyze chunks of a file generated by chunking module 314 to ensure that the chunks adhere to the normalized organizational format.

Chunk system 312 includes data connection module 382 as part of “BACKFILL SCANNING” and which may be a software component configured to normalize data connection outputs. Data connection module 382 may use one or more techniques to normalize data connection outputs, such as associations between files, such as applying ML models or other types of artificial intelligence. For example, data connection module 382 may apply an ML model to associations between files to normalize the associations in accordance with a normalization scheme.

Chunk system 312 may provide a platform for storage and usage of chunked files (e.g., “PLATFORM” as illustrated in FIG. 3). Chunk system 312 may store files for chunking and/or review of previous chunking in backfill database 324 (illustrated as “BACKFILL DB 324” in FIG. 3) as part of the platform for storage and usage of chunked files. Backfill database 324 may be an instance of backfill database 224 as illustrated in FIG. 2 and/or backfill database 124 as illustrated in FIG. 1. For instance, chunk system 312 may provide files from backfill database 324 for chunking by chunking module 314 in accordance with a normalized organizational format specified by normalization module 380.

Chunk system 312 may store chunks in a datastore, such as chunk tables database 322 (illustrated as “CHUNK TABLES DB 322”). Chunk tables database 322 may be an instance of chunk tables database 222 as illustrated in FIG. 2 and/or chunk tables database 122 as illustrated in FIG. 1. For instance, chunk system 312 may store indications of chunks in chunk tables database 322 in one or more tables. In some examples, chunk system 312 may provide chunk tables database 322 as a system object of chunk system 312.

Chunk system 312 may output chunks and other information as part of “OUTPUT” as illustrated in FIG. 3. For instance, chunk system 312 includes enriched chunk database 326 (illustrated as “ENRICHED CHUNK DB 326”), which may be an output component of chunk system 312 configured to store chunked copies of files. Enriched chunk database 326 may be an instance of enriched chunk database 226 as illustrated in FIG. 2. For example, chunk system 312 may store chunked versions of files (e.g., as individual chunks) within enriched chunk database 326 for use in generating embeddings. Chunk system 312 may provide enriched chunk database 326 as an output component of chunk system 312.

Chunk system 312 includes embedding module 376, which may be an instance of embedding module 276 as illustrated in FIG. 2 and configured to generate vectors of chunks. For instance, chunk system 312 may provide chunks from enriched chunk database 326 to embedding module 376 for embedding module 376 to generate vectors based on the chunks. Embedding module 376 may generate the vectors and provide the vectors to one or more other recipients, such as a vector database, e.g., vector database 388. Chunk system 312 may execute embedding module 376 as an output component of chunk system 312.

Chunk system 312 includes vector database 388 (illustrated as “VECTOR DB 388”), which may be an instance of vector database 288 as illustrated in FIG. 2 and may be configured to store vectors. Embedding module 376 may store vectors and/or other embeddings in vector database 388 for use by chunk system 312 and/or devices/systems. For example, chunk system 312 may store vectors in vector database 388 before sending the vectors to a record system for use by ML models. In some examples, chunk system 312 may provide vector database 388 as an output component of chunk system 312.

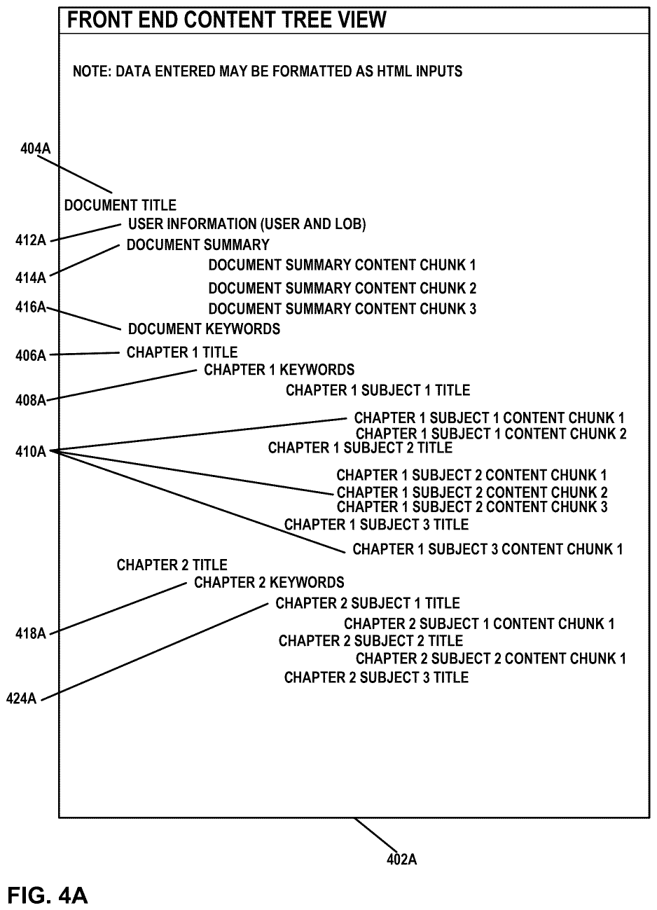

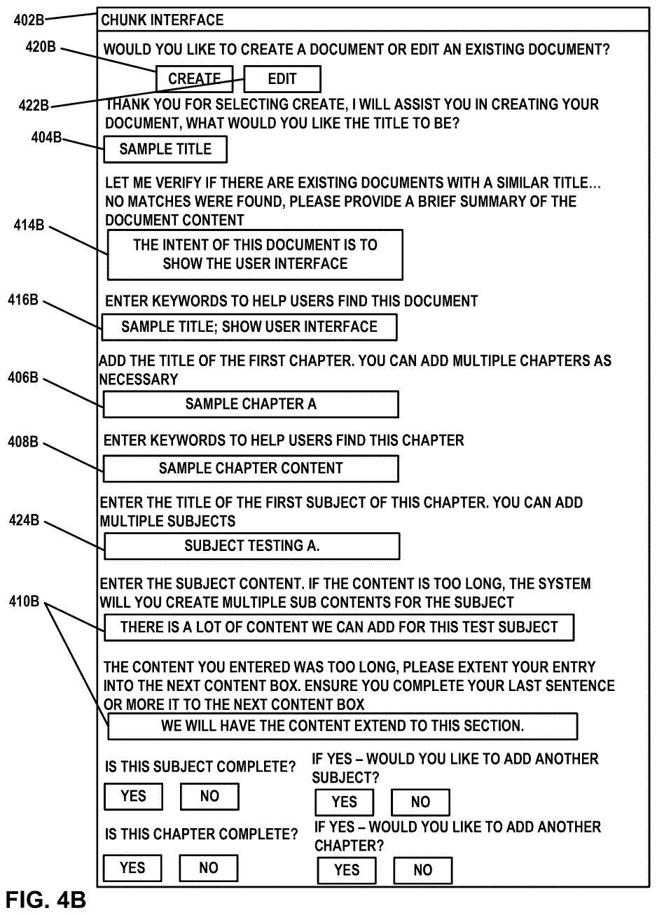

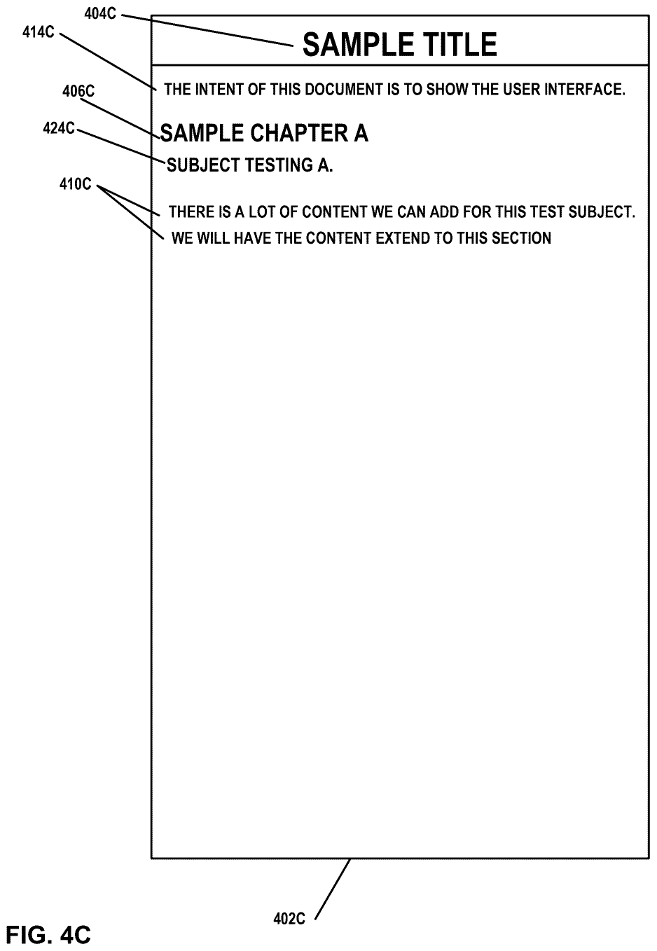

FIGS. 4A-4C are example user interfaces for segmenting the contents of files into chunks, in accordance with one or more aspects of this disclosure. FIGS. 4A-4C are described in the context of FIG. 1. For instance, UI module 120 of chunk system 112 may generate the UIs illustrated in FIGS. 4A-4C.

FIG. 4A illustrates UI 402A, which may be a user interface generated by UI module 120. UI module 120 may generate UI 420A as including one or more UI elements, such as document tree UI elements. In the example of FIG. 4A, UI module 120 generates UI 402A as including document tree UI elements that include a document title UI element 404A (e.g., “DOCUMENT TITLE”), chapter keyword UI elements 408A (e.g., “CHAPTER 1 KEYWORDS”, “CHAPTER 2 KEYWORDS”, etc.), chapter title UI elements 406A (e.g., “CHAPTER 1 TITLE”, CHAPTER 2 TITLE”, etc.), content chunk UI elements 410A (e.g., “CHAPTER 1 SUBJECT 1 CONTENT CHUNK 1”, “CHAPTER 1 SUBJECT 2 CONTENT CHUNK 2”, “CHAPTER 1 SUBJECT 3 CONTENT CHUNK 1”, etc.). In addition, UI module 120 may generate UI 402A as including other UI elements, such as user information UI elements 412A (e.g., information regarding the user who creates/modifies the file, “USER INFORMATION (USER AND LOB)”), file summary UI elements 414A (e.g., “DOCUMENT SUMMARY”, “DOCUMENT SUMMARY CONTENT CHUNK 1”, etc.), document keyword UI elements 416A (e.g., “DOCUMENT KEYWORDS”), subject title UI elements 418A (“CHAPTER 2 SUBJECT 1 TITLE”), chapter subject title UI elements 424A (e.g., “CHAPTER 2 SUBJECT 1 TITLE”), and/or other UI elements.

In some examples, UI module 120 may generate UI 402A based on a normalized organizational format. UI module 120 may generate UI 402A as including UI elements (e.g., UI elements representative of sections of a document tree) corresponding to portions of the normalized organizational format. For example, UI module 120 may generate UI 402A as including UI elements that correspond to different portions of a normalized organizational format for a policy document of the institution. UI module 120 may use UI 402A to enable a user to compose or edit the contents of a file to adhere to a normalized organizational format.

UI module 120 may generate UI 402B of FIG. 4B as including UI elements to enable a user to create or edit an existing file. In the example of FIG. 4B, UI module 120 generates UI 402B as including visual elements that correspond to the creation of a new document, such as create document element 420B, (e.g., “CREATE”) and to edit a preexisting document, such edit document element 422B (e.g., “EDIT”). UI module 120 may receive user input selecting the option to create a new document and generate a UI element that enables a user to first enter the title of the document in document title UI element 404B (e.g., “SAMPLE TITLE”). In some examples, chunk system 112 may determine whether there are existing documents with titles that are within a predetermined threshold of similarity to the title entered by the user.

UI module 120 may generate UI 402B as including UI elements that correspond to sections of the normalized organizational format to enable a user to enter the contents of the document. UI module 120 may use the UI elements to enable a user to enter the contents of the document in accordance with the normalized organizational formation. For instance, as illustrated in FIG. 4B UI module 120 generates UI 402B as including document summary UI element 414B, document keywords UI element 416B, chapter title UI element 406B, chapter keywords UI element 408B, chapter subject title UI element 424B, content chunk UI element 410B and/or other UI elements. In some examples, UI module 120 may generate UI 402B as an overlay or as part of a word processing program (e.g., as a plugin).

UI module 120 may generate UI 402C of FIG. 4C to enable a user to view a published version or representation of a file. In some examples, UI module 120 may generate UI 402B and 402C for simultaneous display (e.g., alongside each other) to enable a user to visualize the published appearance of a file as the user enters the contents of the file. UI module 120 may generate UI 402C based on content entered by a user into the fields of UI 402B. In the example of FIG. 4C, UI module 120 generates UI 402C as including document title UI element 404C, chapter title UI element 406C, content chunk UI elements 410C, file summary UI element 414C, and chapter subject title UI element 424C corresponding to content composed by a user (e.g., as shown in FIG. 4B).

In some examples, UI module 120 may generate UI 402C as including visual indications of boundaries of the subset of the contents of the file to which one or more chunks correspond. UI module 120 may receive indications of the boundaries of the chunks and generate UI 402C based on the boundaries. For example, UI module 120 may generate UI 402C as including a published representation of a file and as including lines representative of the boundaries of chunks within the published representation of the file.

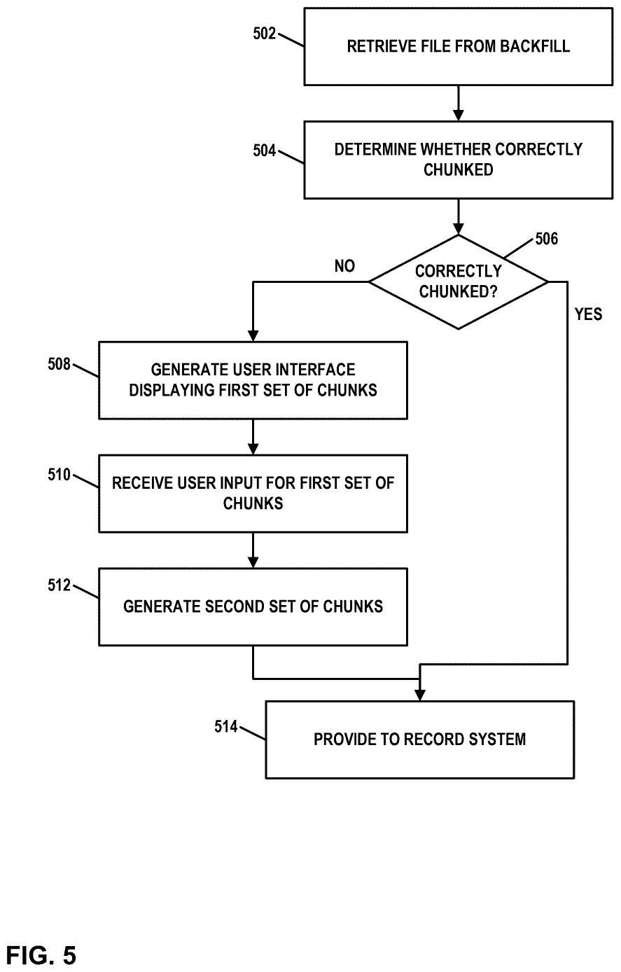

FIG. 5 is a flow diagram illustrating an example process of chunk verification, in accordance with one or more aspects of the present disclosure. FIG. 5 is described in the context of FIG. 1. For example, chunk system 112 may perform one or more of the steps illustrated in FIG. 5.

Chunk system 112 retrieves a file from a backfill, such as backfill database 124 (502). Chunk system 112 may retrieve files that include web pages, documents, presentations, and/or other types of files that have been previously chunked. For example, chunk system 112 may retrieve a document that has been previously chunked from backfill database 124 for review as part of a periodic review of previous chunked documents. Chunk system 112 may obtain files based on one or more factors, such as determining that a file has not been reviewed by chunk system 112, in response to an indication of an issue with a file, based on a flag indicating live/published data, periodic analysis of files, user selection of a file, and/or other factors. In some examples, chunk system 112 may retrieve the file from a file store that maintains a plurality of files (e.g., record system 116) based on determining that the file has been incorrectly chunked.

Chunk system 112 determines whether the retrieved file has been correctly chunked (504). Chunk system 112 may use one or more techniques to determine whether the file has been correctly chunked. For example, chunk system 112 may determine that the file has been incorrectly chunked based on the boundaries of chunks falling within sentences (e.g., the chunks breaking up sentences).

Responsive to determining that the file has been correctly chunked (YES branch of 506), chunk system provides the file to a record system, such as record system 116 (514). Chunk system 112 may provide the file and indications of the boundaries of the chunks and/or vectors of the chunk to record system 116 for consumption by other devices/systems (e.g., support system 118). For example, chunk system 112 may generate vectors of the chunks of the file and provide the vectors to record system 116.

Responsive to determining that the file has not been correctly chunked (NO branch of 506), chunk system 112 generates a UI including a first set of chunks of the file (508). Chunk system 112 may use UI module 120 to generate the UI as including UI elements corresponding to the first set of chunks. For example, UI module 120 may generate a UI that includes UI elements that visually indicate the boundaries of chunks within the file. UI module 120 may generate the UI to enable a user to correct or otherwise provide feedback on the chunks.

Chunk system 112 receives user input, such as user input 132, for the first set of chunks (510). Chunk system 112 may receive one or more types of user input via the UI, such as modification of boundaries of the chunks within the contents of the file, indications of approval for chunks (e.g., indications that a particular chunk is correct), modifications to associations between chunks and portions of a normalized organizational format, and/or other input for the first set of chunks displayed via the UI. In an example, UI module 120 generates a UI as including UI elements, where each UI element corresponds to a chunk of the first set of chunks. UI module 120 receives user input consistent with modification of the boundaries of the chunks and provides an indication of the user input to other components of chunk system 112.

Chunk system 112 generates a second set of chunks based at least in part on user input 132 (512). Chunk system 112 may use one or more components to generate the chunks, such as chunking module 114. For example, chunking module 114 may process the user input and generate a second set of chunks for the file based on the user input. Chunk system 112 may request additional review of the second set of chunks. For instance, chunk system 112 may provide the second set of chunks to a second, different user for secondary verification and provide the second set of chunks to a recipient based on the secondary verification. In some examples, chunk system 112 may use user input 132 as part of a feedback loop to improve automated chunking of files (e.g., using user feedback 132 to modify the automated chunking process and improve the accuracy of future automated chunking).

Chunk system 112 provides the second set of chunks to record system 116 (514). Chunk system 112 may provide the second set of chunks in one or more formats, such as vectors of the chunks, the file appended with indications of the boundaries of the chunks within the contents of the file, the chunks as standalone data elements, tables indicating the boundaries and/or contents of the chunks, and/or other formats.

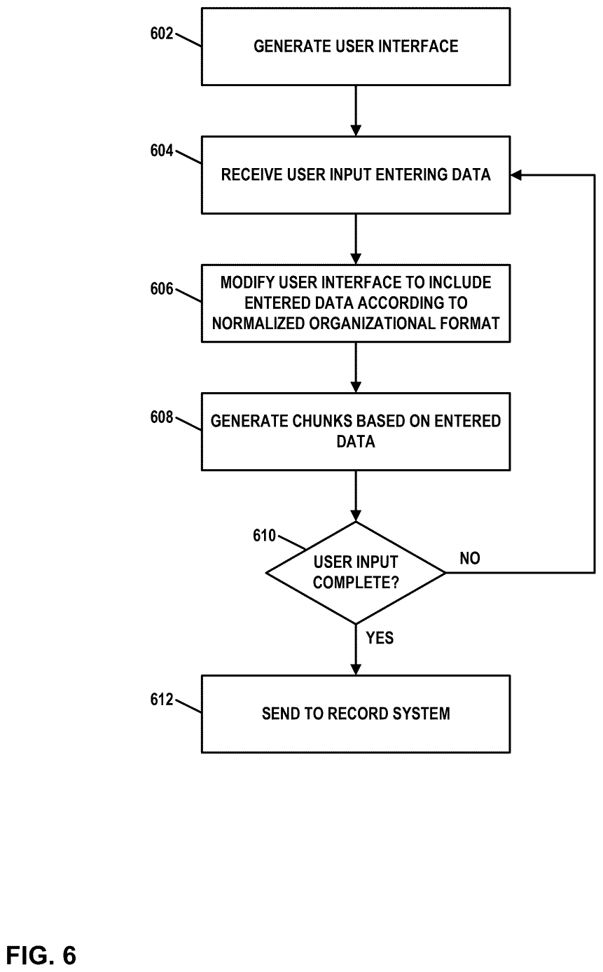

FIG. 6 is a flow diagram illustrating an example process of generating chunks as a user enters data, in accordance with one or more aspects of the present disclosure. FIG. 6 is described in the context of FIG. 1. For example, chunk system 112 may perform one or more of the operations illustrated in FIG. 1.

A system, such as chunk system 112, generates a user interface (602). Chunk system 112 may use one or more components, such as UI module 120, to generate a user interface with one or more UI elements. For example, UI module 120 may generate a UI that includes UI elements corresponding to fields of a normalized organizational format for a type of file.

Chunk system 112 receives user input, such as user input 132, entering data into the UI (604). Chunk system 112 may receive user input 132 as including one or more types of user input, such as entering data into fields of the UI (e.g., text, images, audio clips, etc.), modifying boundaries of chunks to be created based on the entered data, and/or other types of user input. In an example, chunk system 112 receives user input entering text into fields of the UI that correspond to portions of a normalized organizational format for a policy document.

UI module 120 modifies the UI to include entered data according to a normalized organizational format (606). UI module 120 may modify the UI in one or more ways, such as displaying the entered data in fields of the user interface, generating a second “window” or other type of UI element to display the entered information in a published representation, and/or other ways of modifying the user interface. In an example, UI module 120 receives user input entering data into fields of the UI. UI module 120 modifies the UI to visually display the entered data in fields of the UI and to visually display a published representation of the file as the user composes the content of the file, where the published representation is representative of an appearance of the contents of the file when published. In some examples, UI module 120 may display an indication that a user-defined chunk is too large (e.g., that the chunk exceeds a token size limit).

Chunk system 112 generates chunks based on the entered data (608). Chunk system 112 may use one or more components, such chunking module 114, to generate chunks as a user enters data and/or after the user completes entering data for a file. Chunking module 114 may generate the chunks in one or more ways, such as segmenting the contents of the file (e.g., the entered data), generating a table as including indications of the boundaries of the chunks within the file, and/or other ways.

Chunk system 112 may determine whether a user has finished entering data into the UI (610). Responsive to determining that the user has not finished entering data (NO branch of 610), chunk system 112 waits for further user input entering data.

Chunk system 112 sends the generated chunks to a record system (612) responsive to determining that the user has finished entering data (YES branch of 610). Chunk system 112 may send the generated chunks to a record system, such as record system 116, in one or more ways. For instance, chunk system 112 may provide a table with indications of boundaries of the chunks to record system 116 along with the file. In some examples, chunk system 112 may provide vectors of the chunks to record system 116.

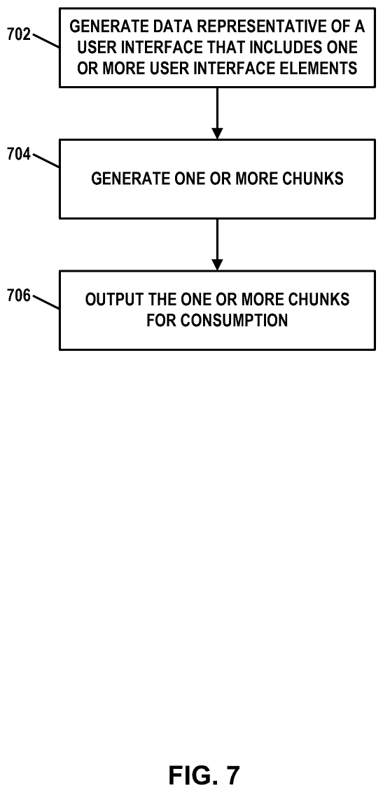

FIG. 7 is a flow diagram illustrating operations performed by an example chunking system, in accordance with one or more aspects of the present disclosure. FIG. 7 is described in the context of FIG. 1.

A computing system, such as chunk system 112, generates data representative of a UI that includes one or more UI elements (702). Chunk system 112 may use one or more components, such as UI module 120, to generate the UI with each of the one or more UI elements corresponding to a portion of a normalized organizational format. For instance, UI module 120 may generate the UI based on a normalized organizational format associated with a type of file, such as a document, presentation, webpage, and/or other type of file.

Chunk system 112 generates one or more chunks based on receiving user input segmenting contents of a file via the UI elements (704). Chunk system 112 may use one or more components, such as chunking module 120, to generate chunks in one or more ways, such as segmenting the file into smaller files that each contain a chunk, generating a table that includes indications of boundaries of chunks within the contents of the file, and/or other ways. Chunking module 120 may generate the chunks as subsets of the contents of the file that include one or more tokens and that satisfy a token size limit. In an example, chunk system 112 receives user input segmenting the contents of a document. Chunking module 120 generates chunks of the file based on the user input by modifying a table to include indications of the boundaries of the chunks within the contents of the file. Chunking module 120 may use the token size limit to avoid generating chunks that exceed a maximum token size of one or more systems configured to consume the chunks. In some examples, chunking module 120 may generate chunks as a user composes or modifies the contents of a file.

Chunk system 112 outputs the one or more chunks for consumption by another computing system (706). Chunk system 112 may output the chunks to a computing system, such as record system 116, for storage of the chunks and/or to a support system, such as support system 118, for use in supporting users. Chunk system 112 may output vectorized versions of the chunks for use by models and/or other systems provided by support system 118. For example, chunk system 112 may provide vectors of chunks for consumption by models provided by support system 118 to support users of the institution.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., analysis computing system 112 as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
generating, by the computing system, data representative of a user interface that includes one or more user interface elements, wherein each of the one or more user interface elements corresponds to a portion of a normalized organizational format;
based on receiving user input segmenting contents of a file via the user interface elements, generating, by the computing system, one or more chunks, wherein each chunk of the one or more chunks is a subset of the contents of the file that includes one or more tokens and satisfies a token size limit; and
outputting, by the computing system, the one or more chunks for consumption by another computing system.

2. The method of claim 1, further comprising:
generating, by the computing system, a vector of each of the one or more chunks, and
wherein outputting the one or more chunks further comprises modifying a vector database to include the vector of each of the one or more chunks.

3. The method of claim 1, further comprising:
receiving user input via the user interface composing the contents of the file.

4. The method of claim 3, wherein generating the data representative of the user interface further comprises:
generating a published representation of the file as the file is composed, wherein the published representation is representative of an appearance of the contents of the file when published.

5. The method of claim 4, wherein generating the published representation of the file further includes generating, within the published representation of the file, visual indications of boundaries of the subset of the contents of the file to which the one or more chunks correspond.

6. The method of claim 1, wherein the one or more user interface elements include one or more document tree user interface elements, and wherein the one or more document tree user interface elements include at least one of:
a document title user interface element,
a user information element,
a document summary element,
a document keyword user interface element,
a chapter title user interface element,
a chapter subject title element, or
a chapter subject content chunk user interface element.

7. The method of 1, further comprising:
determining, by the computing system, that the file has been incorrectly chunked by an automated chunking process, and
wherein generating the data representative of the user interface further comprises generating visual indications of boundaries of incorrect chunks within the contents of the file.

8. The method of claim 7, wherein the file is a file of a plurality of files maintained in a file store,
wherein determining that the file has been incorrectly chunked further comprises analyzing the plurality of files using a language model, and
wherein the method further comprises retrieving the file from the file store based on determining that the file has been incorrectly chunked.

9. The method of claim 7, further comprising:
receiving, by the computing system, user input modifying the boundaries of the incorrect chunks within the contents of the file, and
wherein generating the one or more chunks includes generating the one or more chunks based on the user input.

10. The method of claim 9, further comprising;
modifying, by the computing system and based on the user input modifying the boundaries of the incorrect chunks, the automated chunking process.

11. The method of claim 7, further comprising:
obtaining, by the computing system and via the user interface, verification from a first user that the file has been correctly chunked; and
providing, by the computing system, the file to a second user for secondary verification,
wherein outputting the at least one chunk is based on the verification from the first user and the secondary verification from the second user.

12. A system, comprising:
memory; and
processing circuitry in communication with the memory and configured to:
generate data representative of a user interface that includes one or more user interface elements, wherein each of the one or more user interface elements corresponds to a portion of a normalized organizational format;
based on receiving user input segmenting contents of a file via the user interface elements, generate one or more chunks, wherein each chunk of the one or more chunks is a subset of the contents of the file that includes one or more tokens and satisfies a token size limit; and
output the one or more chunks for consumption by another computing system.

13. The system of claim 12, wherein the processing circuitry is further configured to:
generate a vector of each of the one or more chunks, and
wherein to output the one or more chunks, the processing circuitry is further configured to modify a vector database to include the vector of each of the one or more chunks.

14. The system of claim 12, wherein the processing circuitry is further configured to:
receive user input via the user interface composing the contents of the file.

15. The system of claim 14, wherein to generate the data representative of the user interface, the processing circuitry is further configured to:
generate a published representation of the file as the file is composed, wherein the published representation is representative of an appearance of the contents of the file when published.

16. The system of claim 15, wherein to generate the published representation of the file, the processing circuitry is further configured to:
generate, within the published representation of the file, visual indications of boundaries of the subset of the contents of the file to which the one or more chunks correspond.

17. The system of claim 12, wherein the one or more user interface elements include one or more document tree user interface elements, and wherein the one or more document tree user interface elements include at least one of:
a document title user interface element,
a user information element,
a document summary element,
a document keyword user interface element,
a chapter title user interface element,
a chapter keyword user interface element,
a chapter subject title element, or
a chapter subject content chunk user interface element.

18. The system of claim 12, wherein the processing circuitry is further configured to:
determine that the file has been incorrectly chunked by an automated chunking process, and
wherein to generate the data representative of the user interface, the processing circuitry is further configured to generate visual indications of boundaries of incorrect chunks within the contents of the file.

19. The system of claim 18, wherein the file is a file of a plurality of files maintained in a file store,
wherein to determine that the file has been incorrectly chunked, the processing circuitry is further configured to analyze the plurality of files using a language model, and
wherein the processing circuity is further configured to retrieve the file from the file store based on determining that the file has been incorrectly chunked.

20. Non-transitory computer-readable media configured with instructions that, when executed, cause processing circuitry to:
generate data representative of a user interface that includes one or more user interface elements, wherein each of the one or more user interface elements corresponds to a portion of a normalized organizational format;
based on receiving user input segmenting contents of a file via the user interface elements, generate one or more chunks, wherein each chunk of the one or more chunks is a subset of the contents of the file that includes one or more tokens and satisfies a token size limit; and
output the one or more chunks for consumption by another computing system.
